(19) United States
(12) Patent Application Publication
(10) Pub. No.: US 2014/0085185 A1
(43) Pub. Date: Mar. 27, 2014

(54) MEDICAL IMAGE VIEWING AND MANIPULATION CONTACTLESS GESTURE-RESPONSIVE SYSTEM AND METHOD

(71) Applicant: BETH ISRAEL DEACONESS MEDICAL CENTER, Boston, MA (US)

(72) Inventors: Ammar Sarwar, Jamaica Plain, MA (US); Alexander Bick, Brookline, MA (US); Daniel W. Steinbrook, Marblehead, MA (US)

(21) Appl. No.: 14/006,866

(22) PCT Filed: Mar. 23, 2012
(86) PCT No.: PCT/US12/30275

§ 371 Date: Nov. 25, 2013

Related U.S. Application Data
(60) Provisional application No. 61/467,153, filed on Mar. 24, 2011.

(51) Int. Cl. G06F 3/01; G06T 7/00

(52) U.S. Cl. CPC G06F 3/017; G06T 7/0012
USPC 345/156

(57) ABSTRACT

Viewing and manipulation systems and methods for medical images shown on a display. The method includes the steps of observing a multiple-person medical environment using a camera having a field of view, and sending field-of-view data of the multiple-person medical environment from the camera to a processor. The processor performs the steps of (i) analyzing the field-of-view data to identify a target practitioner and define a target practitioner-based, non-uniform coordinate frame connected to the target practitioner; (ii) monitoring a time-series of the field-of-view data to identify at least one input communicated by a gesture performed by the target practitioner in the target practitioner-based, non-uniform coordinate frame; and (iii) manipulating a medical image shown by the display in response to identifying the at least one input.

### CROSS-REFERENCE TO RELATED APPLICATION

This application claims the benefit of U.S. Provisional Patent Application No. 61/467,153 filed Mar. 24, 2011, the disclosure of which is hereby incorporated by reference in its entirety.

### STATEMENT OF FEDERALLY SPONSORED RESEARCH OR DEVELOPMENT

This invention was made with government support under 2T32GM007753 awarded by the National Institutes of Health. The government has certain rights in the invention.

### BACKGROUND OF THE DISCLOSURE

The present disclosure generally relates to systems and methods for contactless gesture-responsive viewing and manipulation of medical images and, more particularly, to systems and methods that facilitate intuitive and efficient user gestures.

Diagnostic radiologists view and manipulate medical images (for example, magnetic resonance images (MRIs), computer tomography (CT) images, x-ray images or the like) at dedicated computer stations (for example, Picture Archiving and Communication System (PACS) workstations). The tasks can be highly repetitive and require almost exclusive use of a mouse. Studies have shown that up to 98 percent of diagnostic radiologists' computer interaction time involves use of the mouse. This may cause a relatively high rate of repetitive stress injuries compared to other professions. As such, there is a need for improved systems and methods for viewing and manipulating medical images in diagnostic radiology environments.

Similar medical image viewing and manipulation systems have been used in interventional radiology environments. However, in view of sterility requirements of these environments, such systems must be operated by third parties to the operation. Alternatively, some have proposed to use contactless gesture-based inputs from users. While these systems advantageously facilitate medical image viewing and manipulation during a medical procedure, they also have drawbacks. In particular, such systems force practitioners to use uncomfortable and counter-intuitive gestures. For example, performing a gesture at a constant rate (such as holding the elbow stationary and pivoting the forearm over an arc at a constant rate) does not manipulate an image at a constant rate. Instead, the user must pivot the forearm at an increasing rate to manipulate the image at a constant rate. These drawbacks make contactless gesture-responsive systems difficult to learn and decrease image viewing and manipulation efficiency.

Such challenges are greatly exacerbated within the complex environment of operating rooms, which routinely include many people, surgical tools and complex imaging and operating systems. Furthermore, operating room environment and protocols are generally intolerant of faulty or error-prone systems. Unfortunately, previously-proposed contactless gesture-responsive user interface systems have a very high rate of error in interpreting user input or mistaking general user movement as a desired input, which cannot be tolerated when such errors can have dire consequences to productivity, or worse, the outcome of a procedure being performed in the operating room.

Considering the drawbacks of the above medical image viewing and manipulation systems, there is a need for improved contactless, gesture-responsive systems and methods that are appropriate for both diagnostic and interventional radiology environments and advantageously facilitate natural user movements. These systems and methods also advantageously facilitate improved image viewing and manipulation efficiency, speed, and accuracy.

### SUMMARY OF THE INVENTION

The present invention generally provides improved systems and methods for contactless, gesture-responsive viewing and manipulation of medical images (for example, magnetic resonance images (MRIs), computer tomography (CT) images, x-ray images or the like stored in a Picture Archiving and Communication System (PACS)) in both diagnostic and interventional radiology environments. These systems and methods advantageously consider gesture data in a user or practitioner-based, non-uniform coordinate frame. This advantageously facilitates intuitive image manipulations in response to natural practitioner gestures. As such, the practitioner may manipulate images in a relatively low-fatigue and efficient manner.

In one aspect, the present invention provides a medical image viewing and manipulation system that includes a display configured to be disposed in a multiple-person medical environment and show medical images. The system also includes a camera having a field of view matched to at least a selected portion of the multiple-person medical environment. The system further includes at least one processor programmed to perform the steps of (a) receiving field-of-view data of the multiple-person medical environment from the camera; (b) analyzing the field-of-view data of the multiple-person medical environment to identify a target practitioner and define a target practitioner-based, non-uniform coordinate frame connected to the target practitioner; (c) monitoring a time-series of images of the field of view of the multiple-person medical environment to identify at least one input communicated by a pose change of the target practitioner in the target practitioner-based, non-uniform coordinate frame; and (d) manipulating a medical image shown by the display in response to identifying the at least one input.

In another aspect, the present invention provides a method for manipulating a medical image shown on a display. The method includes the steps of observing a medical environment using a camera having a field of view matched to at least a selected portion of the medical environment, and sending field-of-view data of the medical environment from the camera to at least one processor. The processor performs the steps of (i) analyzing the field-of-view data to identify a target practitioner; (ii) defining a target practitioner-based, non-uniform coordinate frame connected to the target practitioner; (iii) monitoring a time-series of images of the field of view to identify at least one input communicated by a gesture performed by the target practitioner in the target practitioner-based, non-uniform coordinate frame; and (iv) manipulating a medical image shown by the display in response to identifying the at least one input.

In yet another aspect, the present invention provides an a computer-readable medium having encoded thereon instructions which, when executed by at least one processor, execute a method for manipulating a medical image shown on a display. The method includes observing a multiple-person medical environment using a camera having a field of view matched to at least a selected portion of the multiple-person medical environment. Field-of-view data of the multiple-person medical environment is sent from the camera to the processor. The processor analyzes the field-of-view data to identify a target practitioner and define a target practitioner-based, non-uniform coordinate frame connected to the target practitioner. The processor monitors a time-series of images of the field of view to identify at least one input communicated by a gesture performed by the target practitioner in the target practitioner-based, non-uniform coordinate frame. The processor also manipulates the medical image shown by the display in response to identifying the at least one input.

The foregoing and other objects and advantages of the invention will appear in the detailed description that follows. In the description, reference is made to the accompanying drawings that illustrate a preferred configuration of the invention.

### BRIEF DESCRIPTION OF THE DRAWINGS

The present invention will hereafter be described with reference to the accompanying drawings, wherein like reference numerals denote like elements, and:

FIG. 1 is a perspective view of a medical practitioner interacting with a medical image viewing and manipulation contactless gesture-responsive system according to the present invention;

FIG. 2 is a schematic representation of the medical image viewing and manipulation contactless gesture-responsive system of FIG. 1;

FIG. 3 is a perspective view of a camera-based, uniform coordinate frame and reference and target points considered by the system to transform gesture data to a practitioner-based, non-uniform coordinate frame;

FIG. 4 is a flow chart setting forth steps of an image viewing and manipulation sequence conducted by the system of FIG. 1; and

FIGS. 5A-C are perspective views of exemplary gestures for manipulating images displayed by the system of FIG. 1.

### DETAILED DESCRIPTION OF THE INVENTION

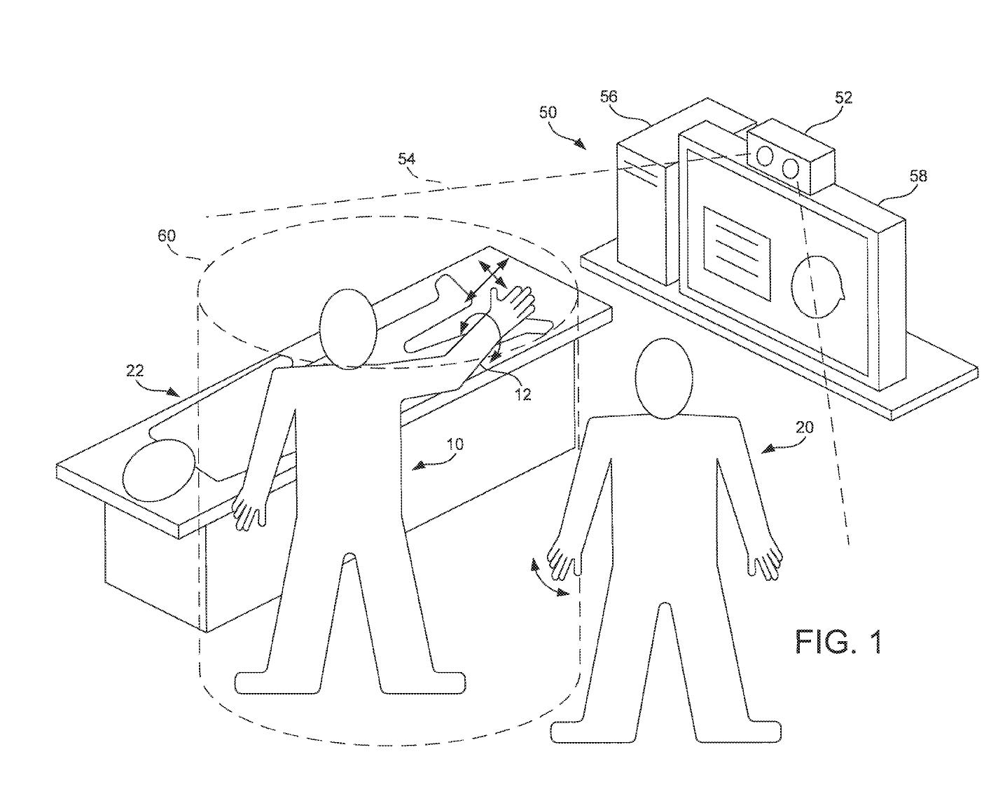

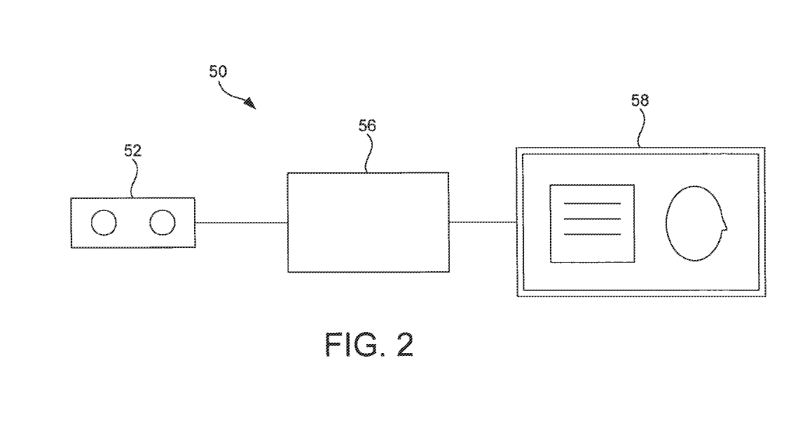

Referring now to the figures and particularly FIGS. 1 and 2, the present invention generally provides an improved system 50 and methods for contactless, gesture-responsive viewing and manipulation of medical images in a multiple-person medical environment (that is, a space configured to accommodate one or more medical practitioners and in which medical-related actions can be performed; for example, both interventional radiology and diagnostic radiology environments). When necessary, the system 50 and method can transform practitioner gesture input data from a camera-based, uniform coordinate frame to a practitioner-based, non-uniform coordinate frame. In other configurations, the system 50 and method are configured to directly establish a practitioner-based, non-uniform coordinate frame. Such a practitioner-based, non-uniform coordinate frame advantageously permits a practitioner 10 to interact with the system 50 with a high degree of accuracy and consistency not available in traditional systems even when the medical environment includes many people and a plethora of tools and systems in operation. The system 50 also allows the practitioner 10 to perform comfortable gestures and manipulate the medical images in an intuitive, relatively low-fatigue, and efficient manner. These aspects are described in further detail below.

Still referring to FIGS. 1 and 2, the system 50 views gestures performed by a target practitioner 10 (for example, an interventional or diagnostic radiologist) via a camera 52 (for example, a three-dimensional camera, such as the Kinect available from the Microsoft Corporation of Redmond, Wash., or the like). The camera 52 creates input data upon viewing gestures performed by the practitioner 10 within the camera's field of view 54. The input data includes images that may be multi-dimensional or contain depth information. The camera 52 also transmits the input data to a processor 56 (for example, a PC or the like). The processor 56 identifies points of interest in the input data (for example, the practitioner's joints or the like) using a feature recognition algorithm (for example, OpenNI Skeleton recognition software or the like) and analyzes motion of the points of interest (that is, pose changes or a time-series of point-of-interest data) using a gesture interpretation algorithm. Based on the output data created by the gesture interpretation algorithm, the processor 56 manipulates medical images shown on an operatively connected display 58 (for example, a LCD or the like). Exemplary practitioner gestures and corresponding exemplary image manipulations are described in further detail below.

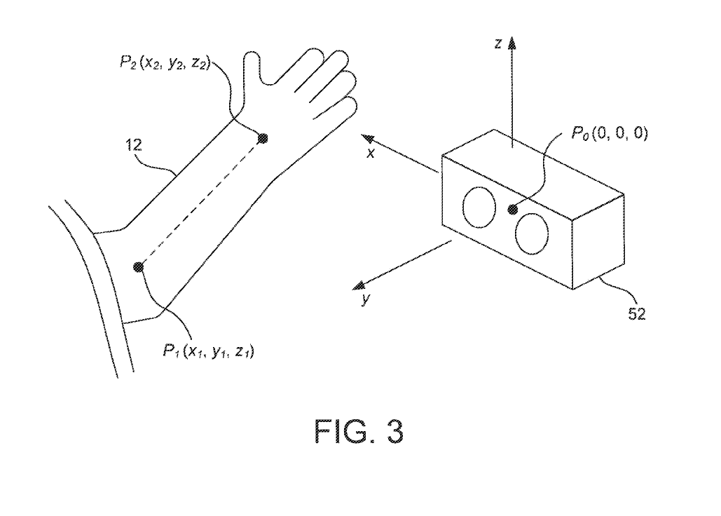

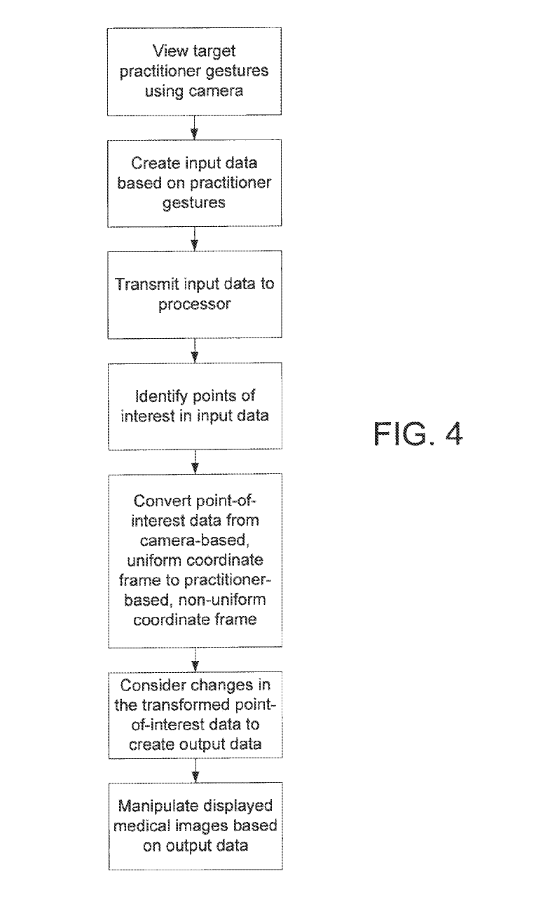

Turning now to FIGS. 2-4 and as briefly described above, the system and method may be adapted to immediately establish a practitioner-based, non-uniform coordinate frame. However, many traditional camera systems are specifically designed to use camera-based, uniform coordinate frames, such as Cartesian coordinate frames. The Kinect from the Microsoft Corporation is an example of a device that uses such a camera-based, uniform coordinate frame. As such, the present invention transforms point-of-interest data from a camera-based, uniform coordinate frame to a practitioner-based, non-uniform coordinate frame. As used herein, “non-uniform” or “projected non-Cartesian” coordinate frames refer to three-dimensional coordinate frames in which two orthogonal coordinates, which are both functions of Cartesian coordinates x and y, are specified in a reference plane and a third coordinate is specified by a perpendicular distance from the reference plane. That is, for non-uniform frame orthogonal coordinates qₖ for (k=1, 2, and 3) in which q₁ and q₂ are in the reference plane:

q₁=f₁(x,y)

q₂=f₂(x,y)

q₃=z

where x and y are Cartesian coordinates in the reference plane and z is the Cartesian coordinate in a direction perpendicular to the reference plane. Stated another way, non-uniform coordinate frames refer to three-dimensional coordinate frames defined by projecting a non-Cartesian two-dimensional coordinate frame, the frame having orthogonal coordinates in a reference plane, in a direction perpendicular to the reference plane. Examples of non-uniform coordinate frames include polar cylindrical coordinate frames, elliptic cylindrical coordinate frames, and parabolic cylindrical coordinate frames. In contrast, uniform coordinate frames include Cartesian coordinate frames and spherical coordinate frames.

In some configurations, the reference plane of the practitioner-based, non-uniform coordinate frame is defined by the orientation of the target practitioner's torso. In particular, the reference plane passes through the target practitioner's torso and is perpendicular to the target practitioner's height. Stated another way, the reference plane is generally parallel to the floor when the target practitioner stands upright.

In configurations where needed, the processor 56 converts camera-based, Cartesian coordinate frame point-of-interest data to practitioner-based, polar cylindrical coordinate frame point-of-interest data. In these configurations, the processor 56 uses the point-of-interest data to calculate an arc-length defined by a reference point of interest P₁ (for example, located at the elbow) of the practitioner 10 and a target point of interest P₂ (for example, located at the wrist on the same arm) in various instantaneous poses. The arc-length, s, is calculated as:

s=(Δx²+Δy²+Δz²)^{1/2} cos⁻¹((Δx²+Δy²−Δz²)/(2ΔxΔy))

where:
Δx=x₂−x₁
Δy=y₂−y₁
Δz=z₂−z₁

By calculating the arc-length s and considering a time-series thereof (that is, by considering arc-length changes to be input gestures), the processor 56 provides a constant medical image manipulation rate over an entire range of motion of a practitioner's appendage. That is, if the practitioner 10 sweeps, for example, the forearm 12 over an arc at a constant rate, the system 50, for example, scrolls through a series of medical images at a constant rate. Tests have shown that such features facilitate improved image manipulation efficiency, speed, and accuracy compared to systems that do not transform data from a Cartesian coordinate frame.

The present system and method also have various additional advantages over systems and methods that use camera-based, uniform coordinate frames. For example, the above calculation permits diagnostic radiologists to rest an elbow on a surface during use to advantageously reduce fatigue. While resting, the elbow, the radiologist may sweep the forearm 12 over an arc at a constant rate to manipulate one or more medical images at a constant rate.

As another example and in interventional radiology environments, the system easily distinguishes gestures performed by the target practitioner 10 from those performed by other nearby individuals 20 (FIG. 1). This is possible because the target practitioner's gestures are relatively easy to recognize in a target practitioner-based, polar cylindrical coordinate frame (that is, the target practitioner's gestures are relatively easy to describe in terms of polar cylindrical coordinates r, θ, and z; for example, the target practitioner's gestures could perhaps be described as a simple linear function using polar cylindrical coordinates). In contrast, other individual's gestures are relatively difficult to represent in the target practitioner-based, polar cylindrical coordinate frame (for example, other individuals' gestures could be described as a non-linear or higher-order function using polar cylindrical coordinates in the target practitioner-based coordinate frame). As such, the system 50 is less likely to respond to gestures of other individuals 20.

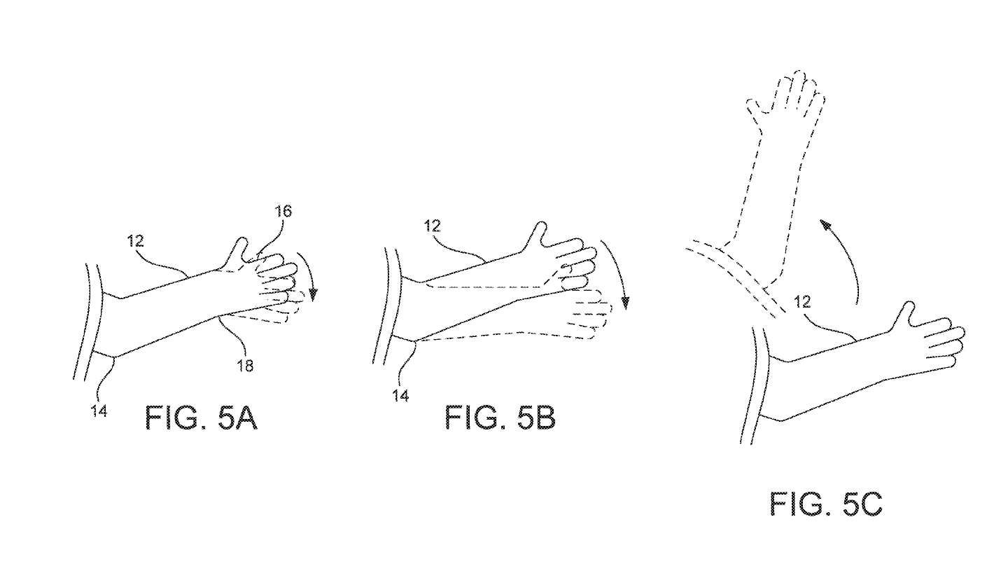

Furthermore, because the target practitioner's gestures are easily recognized by the system 50, at least some of the gestures for manipulating the medical images can be relatively subtle and comfortable. For example and as shown in FIGS. 5A and 5B, subtle and comfortable gestures that use few muscles, such those in which the elbow 14 is supported by a surface (for diagnostic radiology) or those in which the forearm 12 is disposed near the waist (for interventional radiology), can correspond to a frequently-used image manipulation, such as scrolling through a series of images. Subtle and comfortable gestures could alternatively correspond to a sequence of frequently-used image manipulations. In addition, gestures that use relatively small muscle bundles, such as pivoting the hand 16 about the wrist 18 as shown in FIG. 5A, may correspond to manipulations that benefit from relatively precise control, such as fine scrolling. Conversely, gestures that use relatively large muscle bundles, such pivoting the forearm 12 about the elbow 14 as shown in FIG. 5B, may correspond to image manipulations that do not benefit from relatively precise control, such as coarse scrolling.

As another example and as shown in FIG. 5C, relatively “large” gestures (that is, gestures that use various muscles and involve motion about multiple joints), such as raising the forearm 12 above the head, can correspond to less frequently-used image manipulations, such as moving to a new image study. Relatively large gestures could alternatively correspond to a sequence of less frequently-used image manipulations.

Other gestures may correspond to other image manipulations, such as panning, enlarging, condensing, adjusting brightness and/or contrast, and the like. Similarly, other gestures may activate the gesture-responsive system 50 and cause the processor to begin manipulating images according the practitioner's gestures. In an interventional radiology environment, such a gesture may include disposing the target point (for example, the practitioner's wrist) in a specific “activation space” for a brief time period. As used herein, an “activation space” refers to a specific region of three-dimensional space relative to the target practitioner to which part of the target practitioner's body is moved to activate the gesture-responsive system 50.

In addition, in some configurations the location of a specific part of the target practitioner's body (for example, a hand, an elbow, a shoulder, the center of torso, or the like) is considered a gesture or pose change and triggers a manipulation based on its position in a gesture-responsive zone 60 (FIG. 1; that is, a space in which the system responds to the target practitioner's gestures). Similarly, the location of the specific part of the target practitioner's body relative to other parts of the target practitioner's body may trigger a manipulation. In either case, such a manipulation depends on the property ascribed to that gesture, the number or type of the target practitioner's joints in a portion of the gesture-responsive zone 60 simultaneously, and/or the order in which the joints enter or leave the portion of the gesture-responsive zone 60.

In some configurations, presence of a specific part of the target practitioner's body in a specific location changes the operating mode of the system until selection of a different mode. In some configurations, presence and movement of a specific part of the target practitioner's body in a specific location translocates a cursor or objects on the display 58 (that is, when performing mouse manipulating-like action, the system recognizes the gesture in two dimensions and manipulates the cursor in a similar manner on the display 58). In some configurations, presence and movement of a specific part of the target practitioner's body in a specific location increases or decreases a relevant property (for example, movement in one coordinate frame direction, for example, increases or decreases the system volume, scrolls a displayed medical image up or down, or the like).

In some configurations, a menu panel that selects a manipulation to be performed is located along the edge of the display 58 while the portion of the gesture-responsive zone 60 that triggers that manipulation is activated by a different hand. The following specific actions could be used:

“Grab and drop”: Using two hands to indicate selecting a medical image or the cursor and changing the position of the arms, with both hands in equal proximity to the initiating gesture, to indicate the new location of the medical image or cursor.
“Stretch”: increasing the distance between both hands to trigger a response.
“Squash”: decreasing the distance between both hands to trigger a response.
“Wave”: a translocation of a specific point in a plane close to the plane of the users shoulders.
In some configurations, the same gesture (for example, a hand wave) corresponds to different manipulations depending on the location of another joint (for example, the elbow) when the gesture is performed. In some configurations, the system and method differentiate between an open palm, a closed palm, and finger motions.

In addition, the gesture-responsive zone 60 may be matched to only a limited portion of the camera's field of view 54. In these configurations, the gesture-responsive zone 60 is thereby matched to only a desired portion of the multiple-person medical environment. For interventional radiology, the gesture-responsive zone 60 could be limited to within several feet of the display and away from a patient 22. As such, the system will not respond to the target practitioner's gestures when the practitioner 10 interacts with the patient 22. For diagnostic radiology, the gesture-responsive zone 60 may match the majority of the multiple-person medical environment except, for example, a space proximate other PACS workstation input devices (for example, a mouse and a keyboard) or other devices present in a diagnostic radiology environment (for example, a microphone used for dictation). As such, the system will not respond to the target practitioner's gestures when the practitioner interacts with the other PACS input devices or the other diagnostic radiology environment devices.

The system and method may be modified in various manners. For example and as mentioned above, the camera 52 may be configured to initially observe target practitioner gestures in a practitioner-based, non-uniform coordinate frame. As such, the processor 56 need not convert camera-based, uniform coordinate frame gesture data to practitioner-based, non-uniform coordinate frame gesture data.

As another example, the present system may be provided as a software program to be executed by the processor of a workstation that also executes a well-known PACS software program, such as Centricity available from the General Electric Healthcare of Little Chalfont, UK, or the like. In addition, the present system may be appropriate for use with various types of PACS software programs, such as Centricity and the like. Specifically, the present system may use a “look-up” algorithm to convert the output data described above to a specific input form appropriate for a presently-used PACS software program. As a result, identical practitioner input gestures cause identical image manipulations via the PACS software program regardless of the specific program that is used.

As another example, instead of using an external processor 56, the camera 52 may integrally house a processor that analyzes and, where needed, transforms gesture data using the feature recognition and gesture recognition algorithms described above. The camera 52 could then send output data to an external processor (for example, a PC or the like) that executes a well-known PACS software program and thereby manipulate medical images shown on the display 58. Similarly, the system 50 may include multiple processors 56 that together analyze and, where needed, transform gesture data using the feature recognition and gesture recognition algorithms described above. In some configurations, the camera 52 integrally houses one such processor 56, and, for example, a PC or the like houses another such processor 56.

As yet another example, the system and method may monitor gestures of multiple target practitioners in separate practitioner-based, non-uniform coordinate frames. Such systems and methods receive simultaneous input gestures from the multiple target practitioners and manipulate displayed medical images in response thereto. Such implementations may be particularly advantageous, for example, in teaching environments.

From the above disclosure it should be apparent that the present invention provides improved systems and methods for contactless gesture-responsive viewing and manipulation of medical images. These systems and methods advantageously consider gesture data in a practitioner-based, non-uniform coordinate frame. This advantageously facilitates intuitive image manipulations in response to natural practitioner gestures. As such, the practitioner may manipulate images in a relatively low-fatigue and efficient manner.

The various configurations presented above are merely examples and are in no way meant to limit the scope of this disclosure. Variations of the configurations described herein will be apparent to persons of ordinary skill in the art, such variations being within the intended scope of the present application. In particular, features from one or more of the above-described configurations may be selected to create alternative configurations comprised of a sub-combination of features that may not be explicitly described above. In addition, features from one or more of the above-described configurations may be selected and combined to create alternative configurations comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A medical image viewing and manipulation system, comprising:
a display configured to be disposed in a multiple-person medical environment and show medical images;
a camera having a field of view matched to at least a selected portion of the multiple-person medical environment;
at least one processor programmed to perform the steps of:
a. receiving field-of-view data of the multiple-person medical environment from the camera;
b. analyzing the field-of-view data of the multiple-person medical environment to identify a target practitioner and define a target practitioner-based, non-uniform coordinate frame connected to the target practitioner;
c. monitoring a time-series of images of the field of view of the multiple-person medical environment to identify at least one input communicated by a pose change of the target practitioner in the target practitioner-based, non-uniform coordinate frame; and
d. manipulating a medical image shown by the display in response to identifying the at least one input.

2. The system of claim 1, wherein the target practitioner-based, non-uniform coordinate frame is a polar cylindrical coordinate frame.

3. The system of claim 2, wherein monitoring the time-series of the field-of-view data to identify the at least one input communicated by the pose change of the target practitioner includes determining changes of an arc-length s defined as:
s=(Δx²+Δy²+Δz²)^{1/2} cos⁻¹((Δx²+Δy²−Δz²)/(2ΔxΔy))
where:
Δx=x₂−x₁
Δy=y₂−y₁
Δz=z₂−z₁
for P₁(x₁, y₁, z₁) and P₂(x₂, y₂, z₂) where P₁ is a reference point on the practitioner and P₂ is a target point on the user, and xₙ, yₙ, and zₙ for (n=1 and 2) are camera-based, Cartesian coordinates.

4. The system of claim 3, wherein the reference point is the elbow on a first arm of the practitioner and the target point is the wrist on the first arm of the practitioner.

5. The system of claim 1, wherein the step of monitoring the time-series of the field-of-view data includes transforming the field-of-view data from a camera-based, uniform coordinate frame to the target practitioner-based, non-uniform coordinate frame.

6. The system of claim 1, wherein the pose change of the target practitioner includes moving at least a portion of the lower arm of a first arm while the elbow of the first arm engages a surface.

7. A method for manipulating a medical image shown on a display, comprising the steps of:
observing a medical environment using a camera having a field of view matched to at least a selected portion of the medical environment;
sending field-of-view data of the medical environment from the camera to at least one processor, and the processor performing the steps of:
i. analyzing the field-of-view data to identify a target practitioner;
ii. defining a target practitioner-based, non-uniform coordinate frame connected to the target practitioner;
iii. monitoring a time-series of images of the field of view to identify at least one input communicated by a gesture performed by the target practitioner in the target practitioner-based, non-uniform coordinate frame; and
iv. manipulating a medical image shown by the display in response to identifying the at least one input.

8. The method of claim 7, wherein the target practitioner-based, non-uniform coordinate frame is a polar cylindrical coordinate frame.

9. The method of claim 8, wherein monitoring the time-series of the field-of-view data to identify the at least one input communicated by the gesture performed by the target practitioner includes determining changes of an arc-length s defined as:
s=(Δx²+Δy²+Δz²)^{1/2} cos⁻¹((Δx²+Δy²−Δz²)/(2ΔxΔy))
where:
Δx=x₂−x₁
Δy=y₂−y₁
Δz=z₂−z₁
for P₁(x₁, y₁, z₁) and P₂(x₂, y₂, z₂) where P₁ is a reference point on the practitioner and P₂ is a target point on the user, and xₙ, yₙ, and zₙ for (n=1 and 2) are camera-based, Cartesian coordinates.

10. The method of claim 9, wherein the reference point is the elbow on a first arm of the practitioner and the target point is the wrist on the first arm of the practitioner.

11. The method of claim 7, wherein the step of monitoring the time-series of the field-of-view data includes transforming the field-of-view data from a camera-based, uniform coordinate frame to the target practitioner-based, non-uniform coordinate frame.

12. The method of claim 7, wherein the gesture performed by the target practitioner includes moving at least a portion of the lower arm of a first arm while the elbow of the first arm engages a surface.

13. A computer-readable medium having encoded thereon instructions which, when executed by at least one processor, execute a method for manipulating a medical image shown on a display, comprising the steps of:
observing a multiple-person medical environment using a camera having a field of view matched to at least a selected portion of the multiple-person medical environment;
sending field-of-view data of the multiple-person medical environment from the camera to the processor;
analyzing, via the processor, the field-of-view data to identify a target practitioner and define a target practitioner-based, non-uniform coordinate frame connected to the target practitioner;
monitoring, via the processor, a time-series of images of the field of view to identify at least one input communicated by a gesture performed by the target practitioner in the target practitioner-based, non-uniform coordinate frame; and
manipulating, via the processor, the medical image shown by the display in response to identifying the at least one input.

14. The computer-readable medium of claim 13, wherein the target practitioner-based, non-uniform coordinate frame is a polar cylindrical coordinate frame.

15. The computer-readable medium of claim 14, wherein monitoring the time-series of the field-of-view data to identify the at least one input communicated by the gesture performed by the target practitioner includes determining changes of an arc-length s defined as:
s=(Δx²+Δy²+Δz²)^{1/2} cos⁻¹((Δx²+Δy²−Δz²)/(2ΔxΔy))
where:
Δx=x₂−x₁
Δy=y₂−y₁
Δz=z₂−z₁
for P₁(x₁, y₁, z₁) and P₂(x₂, y₂, z₂) where P₁ is a reference point on the practitioner and P₂ is a target point on the user, and xₙ, yₙ, and zₙ for (n=1 and 2) are camera-based, Cartesian coordinates.

16. The computer-readable medium of claim 15, wherein the reference point is the elbow on a first arm of the practitioner and the target point is the wrist on the first arm of the practitioner.

17. The computer-readable medium of claim 13, wherein the step of monitoring the time-series of the field-of-view data includes transforming the field-of-view data from a camera-based, uniform coordinate frame to the target practitioner-based, non-uniform coordinate frame.

18. The computer-readable medium of claim 13, wherein the gesture performed by the target practitioner includes moving at least a portion of the lower arm of a first arm while the elbow of the first arm engages a surface.
